(19) United States
(12) Patent Application Publication
(10) Pub. No.: US 2025/0078308 A1
(43) Pub. Date: Mar. 6, 2025

(54) VIDEO PROCESSING METHOD, DEVICE, ELECTRONIC DEVICE, AND STORAGE MEDIUM

(71) Applicant: Arashi Vision Inc., Shenzhen (CN)

(72) Inventors: Dahao LIN, Shenzhen (CN); Yang XIN, Shenzhen (CN)

(73) Assignee: Arashi Vision Inc., Shenzhen (CN)

(21) Appl. No.: 18/950,624

(22) Filed: Nov. 18, 2024

Related U.S. Application Data
(63) Continuation of application No. PCT/CN2023/094199, filed on May 15, 2023.

(30) Foreign Application Priority Data
May 19, 2022 (CN) 202210546992.2

(51) Int. Cl. G06T 7/70; G06T 3/4038; H04N 23/698

(52) U.S. Cl. CPC G06T 7/70; G06T 3/4038; H04N 23/698

(57) ABSTRACT

Embodiments of the present application disclose a video processing method. The video processing method may include obtaining preview posture data corresponding to a user previewing a panoramic image, and send the preview posture data to a recording device; obtaining panoramic image data from the recording device, the panoramic image data being generated by associating panoramic video data recorded by the recording device with the preview posture data; extracting the preview posture data and the panoramic video data from the panoramic image data; and playing a video corresponding to the panoramic video data according to the preview posture data.

### CROSS REFERENCE TO RELATED APPLICATION

The present application is a continuation of International Application No. PCT/CN2023/094199, filed May 15, 2023, which claims priority to Chinese Patent Application No. CN2022105469922, filed May 19, 2022, the entire content of both of which being incorporated herein by reference in its entirety.

### TECHNICAL OF FIELD

The present application relates to the field of image processing technology, and, in particular, to a video processing method, device, electronic device and storage medium.

### BACKGROUND

In the related art, after a UAV (Unmanned Aerial Vehicle) captures a panoramic video through a camera, it directly transmits the panoramic video to other electronic devices. After other electronic devices obtain the panoramic video, because the panoramic video does not include the user's viewing angle during the recording process, the user needs to manually adjust the viewing angle to watch the video at the corresponding angle.

### SUMMARY

The embodiments of the present application provide a video processing method, device, electronic device and storage medium. The video processing method can play the video corresponding to a panoramic video data at a preview angle of a user when previewing the panoramic image.

In a first aspect, an embodiment of the present application provides a video processing method, including: obtaining preview posture data corresponding to a user previewing a panoramic image, and send the preview posture data to a recording device; obtaining panoramic image data from the recording device, the panoramic image data being generated by associating panoramic video data recorded by the recording device with the preview posture data; extracting the preview posture data and the panoramic video data from the panoramic image data; and playing a video corresponding to the panoramic video data according to the preview posture data.

In a second aspect, an embodiment of the present application provides a video processing device, including: circuitry configured to obtain preview posture data corresponding to a user previewing a panoramic image, and send the preview posture data to a recording device; obtain panoramic image data from the recording device, the panoramic image data being generated by associating panoramic video data recorded by the recording device with the preview posture data; extract the preview posture data and the panoramic video data from the panoramic image data; and play a video corresponding to the panoramic video data according to the preview posture data.

In a third aspect, an embodiment of the present application provides an electronic device, at least one memory storing executable program codes; and at least one processor coupled to the at least one memory; wherein the at least one processor, when executing the executable program codes, is configured to execute the video processing method according to one embodiment of the present application.

In a fourth aspect, an embodiment of the present application provides a non-transitory storage medium, wherein the non-transitory storage medium stores a plurality of instructions, wherein the instructions are executed by a processor to cause the processor to execute the video processing method according to one embodiment of the present application.

In a fifth aspect, an embodiment of the present application provides A system, comprising: a recording device; and a controller, the controller comprising at least one memory storing executable program codes and at least one processor coupled to the at least one memory; wherein the at least one processor, when executing the executable program codes, is configured to: obtain preview posture data corresponding to a user previewing a panoramic image, and send the preview posture data to the recording device; obtain panoramic image data from the recording device, the panoramic image data being generated by associating panoramic video data recorded by the recording device with the preview posture data; extract the preview posture data and the panoramic video data from the panoramic image data; and play a video corresponding to the panoramic video data according to the preview posture data.

In a sixth aspect, an embodiment of the present application provides a video processing method for a recording device, comprising: receiving preview posture data corresponding to a user previewing a panoramic image uploaded by a controller; obtaining recorded panoramic video data, and associating the recorded panoramic video data with the preview posture data to generate panoramic image data.

In some embodiments of the present application, the controller can obtain the preview posture data of a user corresponding to the user's preview of the panoramic image, and send the preview posture data to the recording device; then obtain the panoramic image data sent by the recording device, and the panoramic image data is generated by the recording device according to the recorded panoramic video data and the preview posture data; then extract the preview posture data and the panoramic video data from the panoramic image data; finally, play the video corresponding to the panoramic video data according to the preview posture data. Thus, when playing the video corresponding to the panoramic video data, the video can be played at the user's preview angle.

### BRIEF DESCRIPTION OF THE DRAWINGS

In order to more clearly illustrate the technical solutions in embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a schematic diagram of a scenario in which a recording device and a control device perform data transmission according to an embodiment of the present application.

FIG. 2 is a schematic diagram of a three-dimensional space provided in an embodiment of the present application.

FIG. 3 is a first flow chart of a video processing method in an embodiment of the present application.

FIG. 4 is a second flow chart of the video processing method in an embodiment of the present application.

FIG. 5 is a third flow chart of the video processing method in an embodiment of the present application.

FIG. 6 is a first flow chart of a data processing method in an embodiment of the present application.

FIG. 7 is a schematic diagram of a structure of a video processing device in an embodiment of the present application.

FIG. 8 is a schematic diagram of a structure of a data processing device in an embodiment of the present application.

FIG. 9 is a schematic diagram of the structure of an electronic device provided in an embodiment of the present application.

### DETAILED DESCRIPTION

The following will be combined with the drawings in the embodiments of the present application to clearly describe the technical solutions in the embodiments of the present application. Obviously, the described embodiments are only part of the embodiments of the present application, not all of the embodiments. Based on the embodiments in the present application, all other embodiments obtained by those skilled in the art without creative work are within the scope of protection of this application.

In related technologies, after a UAV captures a panoramic video through a camera, it directly transmits the panoramic video to other electronic devices. After other electronic devices obtain the panoramic video, since the panoramic video does not include the user's viewing angle during the recording process, the user needs to manually adjust the viewing angle to watch the video at the corresponding angle.

In order to solve the above and other technical problems, some embodiments of the present application provide a video processing method, device, electronic device and storage medium. The video processing method can be applied to Virtual Reality (VR) glasses, and can also be applied to various electronic devices such as smart phones and computers.

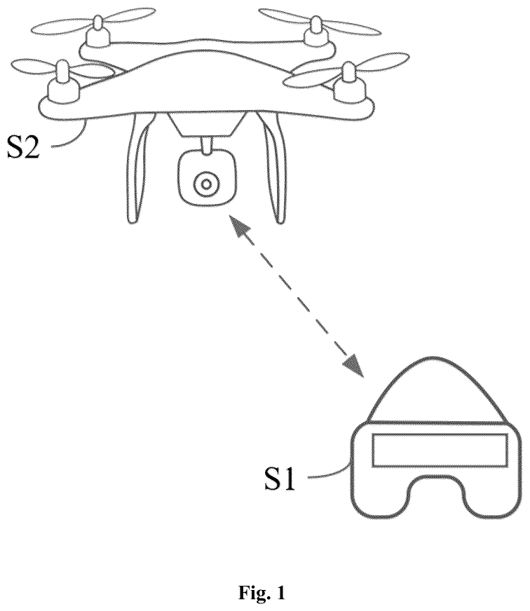

FIG. 1 is a schematic diagram of a scenario in which a recording device and a control device perform data transmission according to an embodiment of the present application.

In one embodiment of the present application, the recording device may record panoramic video data, the control device may preview a panoramic image recorded by the recording device, and the control device may also be used to play the panoramic video data recorded by the recording device.

As shown in FIG. 1, S1 is a control device, S2 is a recording device, the control device may be a VR pair of glasses, and the recording device may be a UAV, which is equipped with a 360-degree panoramic camera. The recording device can record panoramic images in a real three-dimensional space.

It should be noted that the control device may also be a mobile phone, a computer or other electronic device with computing capabilities. The recording device may also be an electronic device such as a panoramic camera. The UAV and VR glasses shown in FIG. 1 are merely examples and should not be regarded as limiting the present application.

Please continue to refer to FIG. 1. In one scenario, after the control device and the recording device establish a communication connection, the recording device can transmit the recorded panoramic image to the control device. The user can preview the panoramic image through the control device. The control device will obtain preview posture data corresponding to the user when the user previews the panoramic image, and then send the preview posture data to the recording device.

For example, the panoramic image previewed by the user on the control device can be a low-resolution image. For example, when the recording device records the panoramic video data recorded by the recording device, the data corresponds to an original panoramic image. but if the recording device transmits the data corresponding to the original panoramic image to the control device, due to the large data, it will cause a high delay in the transmission process, which is not conducive to the user's real-time preview.

Therefore, the recording device can convert the acquired panoramic video data into preview panoramic video data with lower resolution, and then send the preview panoramic video data to the control device. After receiving the preview panoramic video data, the control device can preview the panoramic image according to the preview panoramic video data, and the control device sends preview data of the user when previewing the panoramic image to the recording device. For example, the control device can obtain the preview posture data of the user when previewing the panoramic image through sensors such as a gyroscope and an acceleration sensor.

After the recording device receives the preview posture data, the recording device generates panoramic image data according to the recorded panoramic video data and the preview posture data, and then sends the panoramic image data to the control device.

After the control device receives the panoramic image data, the control device extracts the panoramic image data, thereby extracting the preview posture data and the panoramic video data, and finally plays the video corresponding to the panoramic video data according to the preview posture data.

The control device may determine a preview angle of the user according to the preview posture data, and then play the video corresponding to the panoramic video data according to the preview angle.

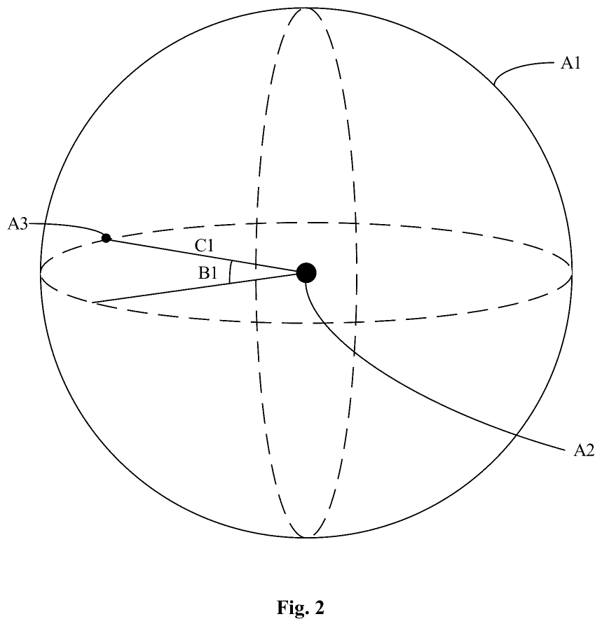

Regarding controlling the device to preview the panoramic image according to the preview panoramic video data, please refer to FIG. 2, which is a schematic diagram of a three-dimensional space provided in an embodiment of the present application.

The control device may first determine a center point A2 of the space, and then establish a three-dimensional space A1, the three-dimensional space corresponds to a stereoscopic space where the recording device is located, and a position of the center point of the space in the three-dimensional space corresponds to a position of the recording device in the real stereoscopic space. In the process of the control device establishing the three-dimensional space, a north direction obtained by the recording device through a fusion magnetometer can be determined as a standard direction corresponding to the center point of the space, and then the three-dimensional space is established based on the standard direction.

The three-dimensional space is a virtual space. When the recording device transmits the preview panoramic video data to the control device, the control device can render the preview panoramic video data in the three-dimensional space to obtain a preview panoramic image.

When the preview panoramic video data transmitted by the recording device is a data stream, what is rendered in the three-dimensional space is a panoramic video.

When the user uses the control device to preview the panoramic image, the control device can use sensors to record the preview posture data corresponding to the user. For example, the preview posture data corresponding to the user may be determined through data recorded by sensors such as a gyroscope and an acceleration sensor.

For example, when a user wears a control device, the control device can obtain the user's preview posture data. For example, when the user turns his head to look in a certain direction, the control device can record the preview posture data corresponding to the direction. The preview posture data can be Euler angle data. The Euler angle is a set of three independent angular parameters used to uniquely determine a position of a fixed-point rotating rigid body, which consists of a nutation angle θ, a precession angle ψ, and a rotation angle φ.

As shown in FIG. 2, when the control device renders a panoramic image or a panoramic video, the control device can determine a corresponding viewing angle B1 and a corresponding viewing distance C1, and determine the screen previewed by the user in the panoramic image or the panoramic video under the viewing angle B1 and viewing distance C1. Then, the screen is displayed on the display area of the control device. The viewing distance C1 is the distance between the spatial center point A2 and the spatial point A3.

For a more detailed understanding of the video processing method provided in one embodiment of the present application, please refer to FIG. 3, which is a schematic diagram of a flow chart of a video processing method provided in one embodiment of the present application. The video processing method may include the following steps:

110: obtaining preview posture data corresponding to a user previewing a panoramic image, and send the preview posture data to a recording device.

In some embodiments, when a user uses a control device to preview a panoramic image sent by a recording device, the control device may record preview posture data of the user and send the preview posture data to the recording device.

For example, the control device can use a gyroscope, an acceleration sensor, etc. to obtain preview posture data corresponding to the user. For example, when the control device is worn by the user or held by the user, the corresponding sensor data can be obtained through the sensor, and then the sensor data can be used to determine the preview posture data of the user. For example, the preview posture data includes Euler angle data, angular velocity data, and/or acceleration data, etc.

In one embodiment, when a user uses a mouse or touch to slide the screen to preview a panoramic image, the control device can convert the user's mouse movement information or finger sliding information into preview posture data corresponding to the user's preview of the panoramic image. For example, the mouse movement information or finger sliding information is used to determine a direction selected by the user when previewing the panoramic image, thereby determining the direction as the preview posture data.

In some embodiments, after the control device obtains the preview posture data of the user, the preview posture data may be associated with a specific time, and then the preview posture data with the associated time may be sent to the recording device.

120: obtaining panoramic image data sent by the recording device, where the panoramic image data is generated by the recording device according to recorded panoramic video data and the preview posture data.

In some embodiments, after the control device sends the preview posture data to the recording device, the recording device generates panoramic image data according to the recorded panoramic video data and the preview posture data. The panoramic image data can be understood as data including image data and posture data.

The control device can receive the panoramic image data sent by the recording device through wireless communication.

130: extracting the preview posture data and the recorded panoramic video data from the panoramic image data.

After acquiring the panoramic image data, the control device may parse the panoramic image data to obtain the recorded panoramic video data and the preview posture data.

For example, the recorded panoramic video data and the preview posture data are panoramic image data generated by a preset encoding format, and the control device can use a corresponding decoding method to decode the panoramic image data to obtain the recorded panoramic video data and the preview posture data.

It should be noted that the control device may also determine the time information corresponding to the preview posture data and the time information corresponding to the recorded panoramic video data, and then make the preview posture data and the recorded panoramic video data of the same time correspond to each other.

In some implementations, when the control device analyzes the panoramic image data, the control device may perform smoothing processing on the panoramic image data, thereby filtering out useless data or noise data therein.

140: playing a video corresponding to the panoramic video data according to the preview posture data.

In some embodiments, when a user needs to play a video corresponding to the panoramic image data, the control device can first determine the starting time of the video to be played, and then determine the preview posture data and the recorded panoramic video data corresponding to the playback starting point based on the starting time, and then render the image corresponding to the panoramic video data according to the preview posture data in chronological order, thereby rendering the image from the preview angle of the user.

When the electronic device continuously displays multiple frames of images at the preview angle, the device is controlled to play the video corresponding to the panoramic image data.

That is to say, in one embodiment, the control device can determine the user's preview angle according to the preview posture data, and then play the video corresponding to the panoramic image data according to the preview angle.

It should be noted that the device for playing the video of the panoramic image data is not limited to the control device, but may also be other electronic devices with playback capabilities.

Please refer to FIG. 2. As shown in FIG. 2, when the preview posture data is Euler angle data, the control device can determine the user's preview angle in three-dimensional space according to the Euler angle data, and determine the image corresponding to the preview angle.

When a display area of the control device displays the images corresponding to multiple preview angles, the video corresponding to the panoramic image data is played at the user's preview angle.

In one embodiment, the control device can obtain the preview posture data corresponding to the user's preview of the panoramic image, and send the preview posture data to the recording device; then obtain the panoramic image data sent by the recording device, and the panoramic image data is generated by the recording device according to the recorded panoramic video data and the preview posture data; then extract the preview posture data and the recorded panoramic video data from the panoramic image data; finally, play the video corresponding to the panoramic video data according to the preview posture data. Thus, when playing the video corresponding to the panoramic video data, the video can be played at the preview angle of the user.

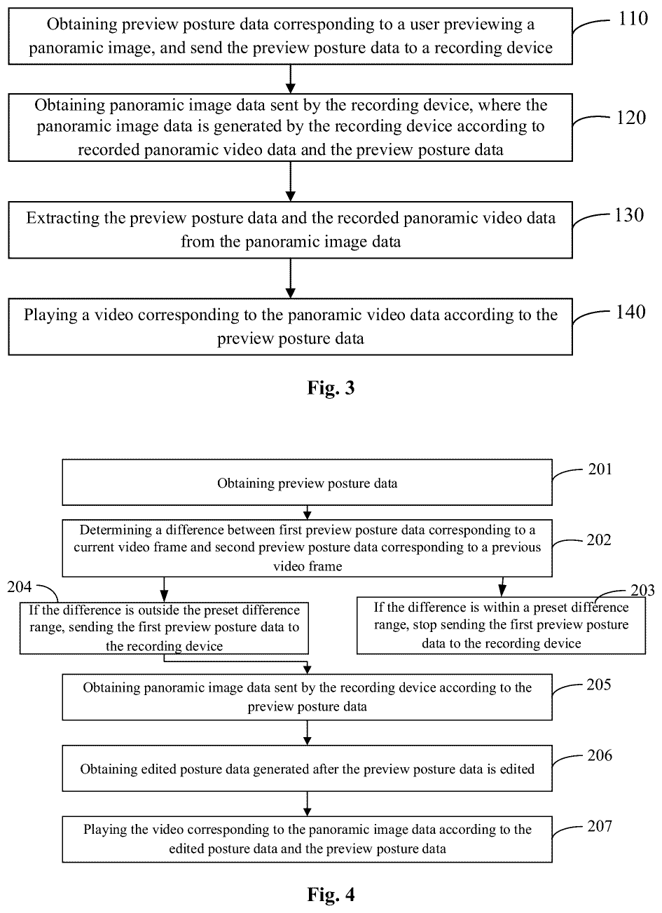

Please continue to refer to FIG. 4, which is a flow chart of a video processing method provided by one embodiment of the present application. The video processing method may include the following steps:

201: obtaining preview posture data.

For example, the control device can use a gyroscope, an acceleration sensor, etc. to obtain preview posture data corresponding to the user. For example, when the control device is worn by the user or held by the user, the corresponding sensor data can be obtained through the sensor, and then the sensor data can be used to determine the preview posture data of the user. For example, the preview posture data includes Euler angle data, angular velocity data, acceleration data, etc.

For another example, when a user uses a mouse or touch to slide the screen to preview a panoramic image, the control device can convert the user's mouse movement information or finger sliding information into preview posture data corresponding to the user's preview of the panoramic image. For example, the mouse movement information or finger sliding information is used to determine a direction selected by the user when previewing the panoramic image, thereby determining the direction as the preview posture data.

202: determining a difference between first preview posture data corresponding to a current video frame and second preview posture data corresponding to a previous video frame.

In some embodiments, the control device may determine first preview posture data corresponding to the current video frame and second preview posture data corresponding to the previous video frame, and then determine a difference between the first preview posture data corresponding to the current video frame and the second preview posture data corresponding to the previous video frame.

When the preview posture data is Euler angle data, the first preview posture data is first Euler angle data, and the second posture data is second Euler angle data.

In one embodiment, the control device converts the first Euler angle data of the current video frame into a first space vector, converts the second Euler angle data of the previous video frame into a second space vector, and finally determines the difference between the first space vector and the second space vector. The difference between the first space vector and the second space vector is the difference between the first preview posture data corresponding to the current video frame and the second preview posture data corresponding to the previous video frame.

203: if the difference is within a preset difference range, stop sending the first preview posture data to the recording device.

In some embodiments, the control device can set a preset difference range. When the difference between the first preview posture data corresponding to the current video frame and the second preview posture data corresponding to the previous video frame is within the preset difference range, it is considered that the preview posture of the user changes very little, such as the user's head changes very little.

For example, the preset difference range is 0 to 5 degrees, and the difference between the first preview posture data corresponding to the current video frame and the second preview posture data corresponding to the previous video frame is 4 degrees, then it is determined that the difference between the first preview posture data corresponding to the current video frame and the second preview posture data corresponding to the previous video frame is within the preset difference range.

At this time, the control device can stop sending the preview posture data of the current video frame to the recording device, reducing the data transmission to the recording device, so that the data volume of the panoramic image data finally generated by the recording device based on the preview posture data and the panoramic image data is smaller. At the same time, it can reduce the transmission of useless data and improve the data transmission efficiency between the data control device and the recording device.

204: if the difference is outside the preset difference range, sending the first preview posture data to the recording device.

In some implementations, if the difference is outside the preset difference range, it means that the user's preview posture has changed significantly when comparing the current video frame with the previous video frame. At this time, the first preview posture data can be sent to the recording device.

205: obtaining panoramic image data sent by the recording device according to the preview posture data.

In some implementations, after the recording device receives the first preview posture data, the recording device may determine a timestamp corresponding to the first preview posture data, and then associate the timestamp with the panoramic image data of the same time.

The recording device may associate multiple frames of preview posture data with the corresponding panoramic image data respectively to generate the panoramic image data.

For example, the preview posture data corresponding to time 10:01 is associated with the corresponding panoramic image data, and the preview posture data corresponding to time 10:02 is associated with the corresponding panoramic image data. In this way, after the preview posture data and the panoramic image data are associated, the panoramic image data is obtained.

The control device can receive the panoramic image data sent by the recording device through wireless communication.

206: obtaining edited posture data generated after the preview posture data is edited.

In some embodiments, after the control device receives the panoramic image data, the user can edit the preview posture data in the panoramic image data to generate edited posture data. For example, after selecting a key frame, the user can edit the preview posture data corresponding to the key frame to obtain edited posture data.

For example, the first key frame corresponds to the first target preview posture data, and after the user edits the first target preview posture data, the first edited posture data corresponding to the first key frame is obtained. The second key frame corresponds to the second target preview posture data, and after the user edits the second target preview posture data, the second edited posture data corresponding to the second key frame is obtained.

In some implementations, the user may also modify other parameters of the panoramic image data, such as changing the viewing angle corresponding to a key frame after the user selects the key frame.

207. playing the video corresponding to the panoramic image data according to the edited posture data and the preview posture data.

In some embodiments, the control device can determine the preview angle of the image corresponding to the key frame through the edited posture data corresponding to the key frame, determine the preview angle of the images corresponding to other frames in the panoramic image data through the preview posture data, and finally play the image corresponding to the key frame through the preview angle of the image corresponding to the key frame, and play the images corresponding to other frames through the preview angle of the images corresponding to other frames.

In some embodiments, the control device can also smooth the posture data corresponding to the panoramic video data of each frame in the panoramic image data through the edited posture data and the preview posture data, and then play the image corresponding to the panoramic video data of each frame in the panoramic image data according to the smoothed posture data.

As such, the video corresponding to the panoramic video data can be played according to the edited posture data and the preview posture data.

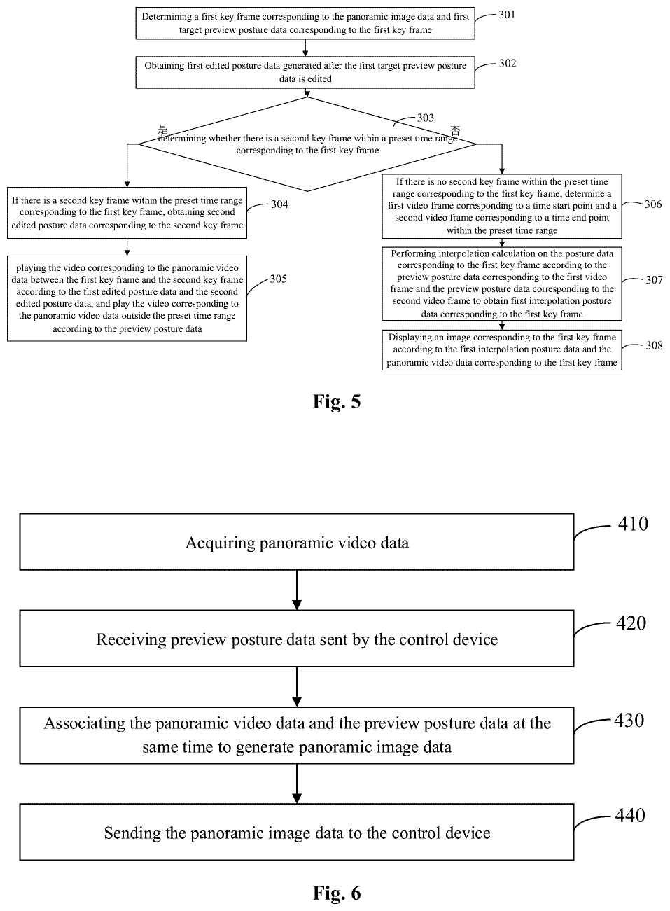

In order to understand in more detail playing the video corresponding to the panoramic video data according to the edited posture data and the preview posture data in one embodiment of the present application, please continue to refer to FIG. 5, which is a schematic diagram of a flowchart of a video processing method provided by one embodiment of the present application. The video processing method may also include the following steps:

301: determining a first key frame corresponding to the panoramic image data and first target preview posture data corresponding to the first key frame.

In some embodiments, taking the first key frame edited by the user as an example, the control device determines the first key frame of the panoramic image data edited by the user and the first target preview posture data corresponding to the first key frame, wherein the first target preview posture data is data extracted from the panoramic image data of the control device. The first key frame is the key frame corresponding to the panoramic video data selected by the user in the panoramic video data.

302: obtaining first edited posture data generated after the first target preview posture data is edited.

For example, the preview posture data is Euler angle data. After the user determines the first key frame, the first target Euler angle data corresponding to the first key frame is edited to obtain the edited Euler angle data corresponding to the first key frame.

303: determining whether there is a second key frame within a preset time range corresponding to the first key frame.

For example, the preset time range corresponding to the first key frame is the first five seconds before the first key frame and the last five seconds after the first key frame. The control device can determine whether there is a second key frame selected for editing by the user within this preset time range.

If there is a second key frame within the preset time range corresponding to the first key frame, the process proceeds to step 304. If there is no second key frame within the preset time range corresponding to the first key frame, the process proceeds to step 306.

304. If there is a second key frame within the preset time range corresponding to the first key frame, obtaining second edited posture data corresponding to the second key frame.

For example, if there is a second key frame within the preset time range corresponding to the first key frame, the control device can determine the second target preview posture data corresponding to the second key frame, and then obtain the second edited posture data generated after the user edits the second target preview posture data.

305: playing the video corresponding to the panoramic video data between the first key frame and the second key frame according to the first edited posture data and the second edited posture data, and play the video corresponding to the panoramic video data outside the preset time range according to the preview posture data.

In one embodiment, the control device can perform interpolation calculation on the posture data corresponding to each frame of panoramic video data between the first key frame and the second key frame based on the first edited posture data and the second edited posture data to obtain the interpolation posture data corresponding to each frame of panoramic video data between the first key frame and the second key frame; and then play the video corresponding to the panoramic video data between the first key frame and the second key frame based on the interpolated posture data.

For example, there are three frames between the first key frame and the second key frame, and the three frames are respectively determined as frame A, frame B, and frame C in time sequence. The control device can calculate the posture data corresponding to frame A, frame B, and frame C respectively according to the first edited posture data and the second edited posture data, thereby obtaining interpolation posture data corresponding to frame A, frame B, and frame C respectively.

Then, the viewing angles corresponding to the frames A, B, and C are determined according to the interpolated posture data, and finally the images corresponding to the frames A, B, and C are played according to the viewing angles, respectively. Thus, the video corresponding to the panoramic video data between the first key frame and the second key frame is played according to the interpolated posture data.

In some embodiments, for panoramic video data outside the preset time range, the corresponding video may be played using preview posture data extracted from the panoramic image data.

For example, the panoramic video data before 5 seconds prior to the first key frame can be used to play the video corresponding to the panoramic video data through the preview posture data.

Through the above method, the posture data of the entire panoramic image data can be smoothed, so that when the video corresponding to the panoramic image data is played, a smoother viewing angle transition playback effect can be achieved without the phenomenon of freezing between video images.

306: if there is no second key frame within the preset time range corresponding to the first key frame, determine a first video frame corresponding to a time start point and a second video frame corresponding to a time end point within the preset time range.

For example, the preset time range corresponding to the first key frame is the first five seconds before the first key frame and the last five seconds after the first key frame. If there is no second key frame within the preset time range corresponding to the first key frame, the control device determines the first video frame corresponding to 5 seconds before the first key frame, and the second video frame corresponding to 5 seconds after the first key frame.

307: performing interpolation calculation on the posture data corresponding to the first key frame according to the preview posture data corresponding to the first video frame and the preview posture data corresponding to the second video frame to obtain first interpolation posture data corresponding to the first key frame.

For example, the control device first obtains the preview posture data corresponding to the first video frame and the preview posture data corresponding to the second video frame from the panoramic image data, and then interpolates the posture data corresponding to the first key frame through the preview posture data corresponding to the first video frame and the preview posture data corresponding to the second video frame, thereby calculating the first interpolation posture data corresponding to the first key frame.

The first edited posture data edited by the user for the first key frame is not adopted.

308: displaying an image corresponding to the first key frame according to the first interpolation posture data and the panoramic video data corresponding to the first key frame.

For example, the control device determines the viewing angle corresponding to the first key frame by using the first interpolation posture data, then determines the panoramic video data corresponding to the first key frame in the panoramic image data, and finally displays the image of the panoramic video data corresponding to the first key frame through the viewing angle corresponding to the first key frame.

In one embodiment, after the control device acquires the panoramic image data, the video corresponding to the panoramic video data can be played at the angle when the user previews the panoramic screen according to the preview posture data in the panoramic image data. If the user edits the preview posture data in the panoramic image data, the video corresponding to the panoramic video data can be played together according to the edited posture data edited by the user and the preview posture data.

In some embodiments, if the edited panoramic image data needs to be played on other devices, the file format of the edited panoramic image data can be converted into a universal format, such as MP4 format. Then, when other devices play the edited panoramic image data, they can directly play the video corresponding to the panoramic video data through the viewing angles corresponding to the edited posture data and the preview posture data.

In one embodiment, the control device obtains the preview posture data, and then determines the difference between the first preview posture data corresponding to the current video frame and the second preview posture data corresponding to the previous video frame. If the difference is within the preset difference range, the first preview posture data is stopped from being sent to the recording device. If the difference is outside the preset difference range, the first preview posture data is sent to the recording device, and then the panoramic image data sent by the recording device according to the preview posture data is obtained, and the edited posture data generated after the preview posture data is edited is obtained, and finally the video corresponding to the panoramic video data is played according to the edited posture data and the preview posture data. Thus, the video corresponding to the panoramic video data is played through the view angles corresponding to the edited posture data and the preview posture data.

Please refer to FIG. 6, which is a flow chart of a data processing method provided in an embodiment of the present application. The data processing method is directed to a recording device, and the data processing method may include the following steps: 410: acquiring panoramic video data.

The recording device is provided with a 360-degree panoramic camera, through which panoramic video data is captured, and the panoramic video data is native data.

The recording device may convert the panoramic video data into preview panoramic video data with lower resolution, and then send the preview panoramic video data to the control device, so that the user can preview the panoramic image corresponding to the preview panoramic video data through the control device. 420: receiving preview posture data sent by the control device.

In some embodiments, the recording device may also obtain preview posture data sent by the control device, and the preview posture data may contain corresponding time information, such as preview posture data at different times corresponding to a timestamp.

430: associating the panoramic video data and the preview posture data at the same time to generate panoramic image data.

In some embodiments, the recording device can associate the panoramic video data and the preview posture data of the same time according to the time information of the preview posture data and the time information of the panoramic video data to generate an associated file; and set the associated file at the end of the panoramic video data to generate panoramic image data.

440: sending the panoramic image data to the control device.

The recording device can send the panoramic image data to the control device by wireless communication.

In one embodiment, the recording device collects panoramic video data, then receives the preview posture data sent by the control device, associates the panoramic video data and the preview posture data at the same time to generate panoramic image data, and finally sends the panoramic image data to the control device. Thus, the user's preview posture data and the panoramic video data are associated.

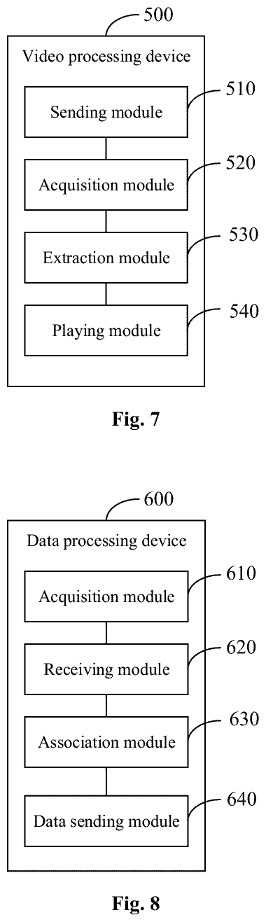

Please refer to FIG. 7, which is a schematic diagram of a structure of a video processing device provided in an embodiment of the present application. The video processing device 500 may include:

a sending module 510, configured to obtain preview posture data corresponding to a user previewing a panoramic image, and send the preview posture data to the recording device.

The sending module 510 is further configured to determine a difference between the first preview posture data corresponding to the current video frame and the second preview posture data corresponding to the previous video frame;

if the difference is outside a preset difference range, sending the first preview posture data to the recording device;

if the difference is within the preset difference range, the sending of the first preview posture data to the recording device is stopped.

The sending module 510 is further configured to convert the first Euler angle data of the current video frame into the first space vector, and convert the second Euler angle data of the previous video frame into the second space vector; and

determining a difference between the first space vector and the second space vector;

an acquisition module 520, configure do acquire the panoramic image data sent by the recording device, where the panoramic image data is generated by the recording device according to the recorded panoramic video data and the preview posture data.

an extraction module 530, configured to extract the preview posture data and the panoramic video data from the panoramic image data.

a playing module 540, configured to play the video corresponding to the panoramic video data according to the preview posture data.

In one embodiment, the playing module 540 is further configured to obtain the edited posture data generated after the preview posture data being edited; and play the video corresponding to the panoramic video data according to the edited posture data and the preview posture data.

In one embodiment, the playback module 540 is further configured to determine the first key frame corresponding to the panoramic image data and the first target preview posture data corresponding to the first key frame; and

acquire the first edited posture data generated after the first target preview posture data being edited.

In one embodiment, the playing module 540 is further configured to determine whether there is a second key frame within a preset time range corresponding to the first key frame;

if there is a second key frame within the preset time range corresponding to the first key frame, obtain second edited posture data corresponding to the second key frame; and

play the video corresponding to the panoramic video data between the first key frame and the second key frame according to the first edited posture data and the second edited posture data, and playing the video corresponding to the panoramic video data outside the preset time range according to the preview posture data.

In one embodiment, the playback module 540 is further configured to perform interpolation calculation on the posture data corresponding to each frame of panoramic image data between the first key frame and the second key frame according to the first edited posture data and the second edited posture data, so as to obtain the interpolation posture data corresponding to each frame of panoramic image data between the first key frame and the second key frame; and

play the video corresponding to the panoramic video data between the first key frame and the second key frame according to the interpolated posture data.

In one embodiment, after determining whether there is a second key frame within the preset time range corresponding to the first key frame, the playback module 540 is further configured to determine a first video frame corresponding to a time start point and a second video frame corresponding to a time end point within the preset time range if there is no second key frame within the preset time range corresponding to the first key frame;

perform interpolation calculation on the posture data of the first key frame according to the preview posture data corresponding to the first video frame and the preview posture data corresponding to the second video frame to obtain first interpolation posture data corresponding to the first key frame; and

display the image corresponding to the first key frame according to the first interpolation posture data and the panoramic image data corresponding to the first key frame.

In one embodiment, the control device can obtain the preview posture data corresponding to the user's preview of the panoramic image, and send the preview posture data to the recording device; then obtain the panoramic image data sent by the recording device, and the panoramic image data is generated by the recording device according to the recorded panoramic video data and the preview posture data; then extract the preview posture data and the panoramic video data from the panoramic image data; finally, play the video corresponding to the panoramic video data according to the preview posture data. Thus, when playing the video corresponding to the panoramic video data, the video can be played at the user's preview angle.

Please refer to FIG. 8, which is a schematic diagram of the structure of a data processing device provided in an embodiment of the present application. The data processing device 600 may include:

an acquisition module 610, configured to acquire panoramic video data;

a receiving module 620, configured to receive the preview posture data sent by the control device;

an association module 630, configured to associate the panoramic video data and the preview posture data of the same time to generate the panoramic image data;

the association module 630 is also configured to associate the initial panoramic video data and the preview posture data of the same time to generate an association file; and

set the associated file at the end of the panoramic video data to generate the panoramic image data;

a data sending module 640, configured to send the panoramic image data to the control device.

In one embodiment, the recording device collects panoramic video data, then receives the preview posture data sent by the control device, then associates the panoramic video data and the preview posture data at the same time, generates panoramic image data, and finally sends the panoramic image data to the control device. Thus, the user's preview posture data and the initial panoramic video data are associated.

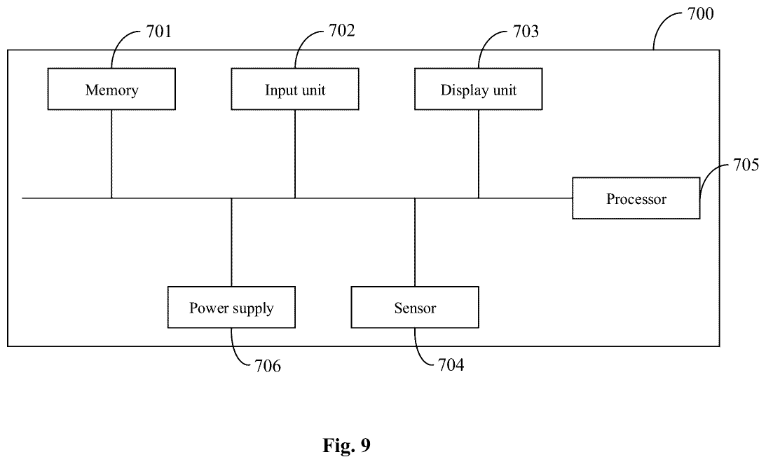

Accordingly, an embodiment of the present application further provides an electronic device, as shown in FIG. 9, the electronic device may include a memory 701 having one or more computer-readable storage media, an input unit 702, a display unit 703, a sensor 704, a processor 705 having one or more processing cores, and a power supply 706. Those skilled in the art will appreciate that the electronic device structure shown in FIG. 9 does not constitute a limitation on the electronic device, and may include more or fewer components than shown, or combine certain components, or arrange components differently. Among them:

The memory 701 can be used to store software programs and modules, and the processor 705 executes various functional applications and data processing by running the software programs and modules stored in the memory 701. The memory 701 may mainly include a program storage area and a data storage area, wherein the program storage area may store an operating system, an application required for at least one function (such as a sound playback function, an image playback function, etc.), etc.; the data storage area may store data created according to the use of the electronic device (such as audio data, a phone book, etc.), etc. In addition, the memory 701 may include a high-speed random access memory, and may also include a non-volatile memory, such as at least one disk storage device, a flash memory device, or other volatile solid-state storage devices. Accordingly, the memory 701 may also include a memory controller to provide the processor 705 and the input unit 702 with access to the memory 701.

The input unit 702 can be used to receive input digital or character information, and generate keyboard, mouse, joystick, optical or trackball signal input related to user settings and function control. Specifically, in one embodiment, the input unit 702 may include a touch-sensitive surface and other input devices. The touch-sensitive surface, also known as a touch display screen or a touch pad, can collect the user's touch operations on or near it (such as the user's operation on or near the touch-sensitive surface using any suitable object or accessory such as a finger, a stylus, etc.), and drive the corresponding connection device according to a pre-set program. Optionally, the touch-sensitive surface may include a touch detection device and a touch controller. Among them, the touch detection device detects the user's touch direction, detects the signal brought by the touch operation, and transmits the signal to the touch controller; the touch controller receives the touch information from the touch detection device, converts it into the touch point coordinates, and then sends it to the processor 705, and can receive and execute the command sent by the processor 705. In addition, the touch-sensitive surface can be implemented using multiple types such as resistive, capacitive, infrared and surface acoustic wave. In addition to the touch-sensitive surface, the input unit 702 may also include other input devices. Specifically, other input devices may include, but are not limited to, one or more of a physical keyboard, function keys (such as a volume control key, a switch key, etc.), a trackball, a mouse, a joystick, and the like.

The display unit 703 can be used to display information input by the user or information provided to the user and various graphical user interfaces of the electronic device, which can be composed of graphics, text, icons, videos and any combination thereof. The display unit 703 may include a display panel. Optionally, the display panel may be configured in the form of a liquid crystal display (LCD), an organic light-emitting diode (OLED), etc. Further, the touch-sensitive surface may cover the display panel. When the touch-sensitive surface detects a touch operation on or near it, it is transmitted to the processor 705 to determine the type of touch event, and then the processor 705 provides corresponding visual output on the display panel according to the type of touch event. Although in FIG. 9, the touch-sensitive surface and the display panel are implemented as two independent components to implement input and output functions, in some embodiments, the touch-sensitive surface and the display panel can be integrated to implement input and output functions.

The electronic device may also include at least one sensor 704, such as a light sensor, a motion sensor, and other sensors. Specifically, the light sensor may include an ambient light sensor and a proximity sensor, wherein the ambient light sensor may adjust the brightness of the display panel according to the brightness of the ambient light, and the proximity sensor may turn off the display panel and/or backlight when the electronic device is moved to the ear. As a type of motion sensor, a gravity acceleration sensor can detect a magnitude of acceleration in each direction (generally three axes), and can detect the magnitude and direction of gravity when stationary. It can be used for applications that identify the posture of the electronic device (such as horizontal and vertical screen switching, related games, magnetometer posture calibration), vibration recognition related functions (such as pedometer, tapping), etc.; as for other sensors that the electronic device can also be equipped with, such as gyroscopes, barometers, hygrometers, thermometers, infrared sensors, etc., they will not be repeated here.

The processor 705 is a control center of the electronic device. It uses various interfaces and lines to connect various parts of the entire electronic device. By running or executing software programs and/or modules stored in the memory 701, and calling data stored in the memory 701, it performs various functions of the electronic device and processes data, thereby monitoring the electronic device as a whole. Optionally, the processor 705 may include one or more processing cores; preferably, the processor 705 may integrate an application processor and a modem processor, wherein the application processor mainly processes the operating system, user interface, and application programs, and the modem processor mainly processes wireless communications. It is understandable that the above-mentioned modem processor may not be integrated into the processor 705.

The electronic device also includes a power supply 706 (such as a battery) for supplying power to various components. Preferably, the power supply can be logically connected to the processor 705 through a power management system, so that the power management system can manage charging, discharging, and power consumption management. The power supply 706 can also include one or more DC or AC power supplies, recharging systems, power failure detection circuits, power converters or inverters, power status indicators, and other arbitrary components.

The electronic device may also include a camera, a Bluetooth module, etc., which will not be described in detail here. In one embodiment, the processor 705 in the electronic device loads the computer program stored in the memory 701, and the processor 705 loads the computer program to achieve various functions:

obtaining the preview posture data corresponding to the user previewing the panoramic image, and sending the preview posture data to the recording device;

obtaining panoramic image data sent by the recording device, where the panoramic image data is generated by the recording device according to the recorded panoramic video data and the preview posture data;

extracting the preview posture data and panoramic video data from the panoramic image data; and

playing the video corresponding to the panoramic video data according to the preview posture data.

A person of ordinary skill in the art will appreciate that all or part of the steps in the various methods of the above embodiments may be completed by instructions, or by controlling related hardware through instructions. The instructions may be stored in a computer-readable storage medium and loaded and executed by a processor.

To this end, an embodiment of the present application provides a computer-readable storage medium, in which a plurality of instructions are stored, and the instructions can be loaded by a processor to execute the steps in any one of the video processing methods provided in the embodiments of the present application. For example, the instructions can execute the following steps:

obtaining the preview posture data corresponding to the user previewing the panoramic image, and send the preview posture data to the recording device;

obtaining panoramic image data sent by the recording device, where the panoramic image data is generated by the recording device according to the recorded panoramic video data and the preview posture data;

extracting preview posture data and panoramic video data from the panoramic image data; and

playing the video corresponding to the panoramic video data according to the preview posture data.

The specific implementation of the above operations can be found in the previous embodiments, which will not be described in detail here.

The storage medium may include: a read-only memory (ROM), a random access memory (RAM), a magnetic disk or an optical disk, etc.

Since the instructions stored in the storage medium can execute the steps in any video processing method provided in the embodiments of the present application, the beneficial effects that can be achieved by any video processing method provided in the embodiments of the present application can be achieved. Please refer to the previous embodiments for details and will not be repeated here.

The above is a detailed introduction to a video processing method, device, electronic device and storage medium provided in the embodiments of the present application. Specific examples are used in this article to illustrate the principles and implementation methods of the present application. The description of the above embodiments is only used to help understand the method of the present application and its core idea; at the same time, for technical personnel in this field, according to the idea of the present application, there will be changes in the specific implementation method and application scope. In summary, the content of this specification should not be understood as a limitation on the present application.

What is claimed is:

1. A video processing method, comprising:
obtaining preview posture data corresponding to a user previewing a panoramic image, and send the preview posture data to a recording device;
obtaining panoramic image data from the recording device, the panoramic image data being generated by associating panoramic video data recorded by the recording device with the preview posture data;
extracting the preview posture data and the panoramic video data from the panoramic image data; and
playing a video corresponding to the panoramic video data according to the preview posture data.

2. The video processing method according to claim 1, wherein the obtaining the preview posture data corresponding to the user previewing the panoramic image and sending the preview posture data to the recording device comprises:
determining a difference between first preview posture data corresponding to a current video frame and second preview posture data corresponding to a previous video frame;
in a case that the difference is outside a preset difference range, sending the first preview posture data to the recording device; and
in a case that the difference is within the preset difference range, stopping sending the first preview posture data to the recording device.

3. The video processing method according to claim 2, wherein the preview posture data comprises Euler angle data, and the determining the difference between the first preview posture data corresponding to the current video frame and the second preview posture data corresponding to the previous video frame comprises:
converting the first Euler angle data of the current video frame into a first space vector, and converting the second Euler angle data of the previous video frame into a second space vector; and
determining a difference between the first space vector and the second space vector.

4. The video processing method according to claim 1, wherein the playing the video corresponding to the panoramic video data according to the preview posture data comprises:
obtaining edited posture data generated after the preview posture data being edited; and
playing the video corresponding to the panoramic video data according to the edited posture data and the preview posture data.

5. The video processing method according to claim 4, wherein the obtaining the edited posture data generated after the preview posture data being edited comprises:
determining a first key frame corresponding to the panoramic image data and first target preview posture data corresponding to the first key frame; and
obtaining the first edited posture data generated after the first target preview posture data being edited.

6. The video processing method according to claim 5, wherein the playing the video corresponding to the panoramic video data according to the edited posture data and the preview posture data comprises:
determining that there is a second key frame within a preset time range corresponding to the first key frame;
obtaining second edited posture data corresponding to the second key frame; and
playing the video corresponding to the panoramic video data between the first key frame and the second key frame according to the first edited posture data and the second edited posture data and playing the video corresponding to the panoramic video data outside the preset time range according to the preview posture data.

7. The video processing method according to claim 6, wherein the playing the video corresponding to the panoramic video data between the first key frame and the second key frame according to the first edited posture data and the second edited posture data comprises:
performing interpolation calculation on the posture data corresponding to each frame of panoramic image data between the first key frame and the second key frame according to the first edited posture data and the second edited posture data to obtain interpolation posture data corresponding to each frame of panoramic image data between the first key frame and the second key frame; and
playing the video corresponding to the panoramic video data between the first key frame and the second key frame according to the interpolated posture data.

8. The video processing method according to claim 5, wherein the playing the video corresponding to the panoramic video data according to the edited posture data and the preview posture data comprises:
determining that there is no second key frame within a preset time range corresponding to the first key frame;
determining a first video frame corresponding to a time start point and a second video frame corresponding to a time end point within the preset time range;
performing interpolation calculation on posture data of the first key frame according to the preview posture data corresponding to the first video frame and the preview posture data corresponding to the second video frame to obtain first interpolation posture data corresponding to the first key frame; and
displaying the image corresponding to the first key frame according to the first interpolation posture data and the panoramic image data corresponding to the first key frame.

9. A video processing method for a recording device, comprising:
receiving preview posture data corresponding to a user previewing a panoramic image uploaded by a controller;
obtaining recorded panoramic video data, and associating the recorded panoramic video data with the preview posture data to generate panoramic image data.

10. The video processing method according to claim 9, further comprising:
sending the panoramic image data to the controller so that the controller plays a video corresponding to the panoramic image data according to the preview posture data.

11. The video processing method according to claim 9, wherein the obtaining the recorded panoramic video data and associating the panoramic video data with the preview posture data to generate the panoramic image data comprises:
obtaining time information corresponding to the preview posture data and time information corresponding to the panoramic video data; and
correlating the preview posture data and the panoramic image data, both of which having the same time information, to generate the panoramic image data.

12. A system, comprising:
a recording device; and
a controller, the controller comprising at least one memory storing executable program codes and at least one processor coupled to the at least one memory;
wherein the at least one processor, when executing the executable program codes, is configured to:
obtain preview posture data corresponding to a user previewing a panoramic image, and send the preview posture data to the recording device;
obtain panoramic image data from the recording device, the panoramic image data being generated by associating panoramic video data recorded by the recording device with the preview posture data;
extract the preview posture data and the panoramic video data from the panoramic image data; and
play a video corresponding to the panoramic video data according to the preview posture data.

13. The system of claim 12, wherein the recording device is an unmanned aerial vehicle including a panoramic camera, and the controller is a VR pair of glasses, a mobile phone, or a computer.

14. The system according to claim 12, wherein the obtaining the preview posture data corresponding to the user previewing the panoramic image and sending the preview posture data to the recording device comprises:
determining a difference between first preview posture data corresponding to a current video frame and second preview posture data corresponding to a previous video frame;
in a case that the difference is outside a preset difference range, sending the first preview posture data to the recording device; and
in a case that the difference is within the preset difference range, stopping sending the first preview posture data to the recording device.

15. The system according to claim 14, wherein the preview posture data comprises Euler angle data, and the determining the difference between the first preview posture data corresponding to the current video frame and the second preview posture data corresponding to the previous video frame comprises:
converting the first Euler angle data of the current video frame into a first space vector, and converting the second Euler angle data of the previous video frame into a second space vector; and
determining a difference between the first space vector and the second space vector.

16. The system according to claim 12, wherein the playing the video corresponding to the panoramic video data according to the preview posture data comprises:
obtaining edited posture data generated after the preview posture data being edited; and
playing the video corresponding to the panoramic video data according to the edited posture data and the preview posture data.

17. The system according to claim 16, wherein the obtaining the edited posture data generated after the preview posture data being edited comprises:
determining a first key frame corresponding to the panoramic image data and first target preview posture data corresponding to the first key frame; and
obtaining the first edited posture data generated after the first target preview posture data being edited.

18. The system according to claim 17, wherein the playing the video corresponding to the panoramic video data according to the edited posture data and the preview posture data comprises:
determining that there is a second key frame within a preset time range corresponding to the first key frame;
obtaining second edited posture data corresponding to the second key frame; and
playing the video corresponding to the panoramic video data between the first key frame and the second key frame according to the first edited posture data and the second edited posture data and playing the video corresponding to the panoramic video data outside the preset time range according to the preview posture data.

19. The system according to claim 18, wherein the playing the video corresponding to the panoramic video data between the first key frame and the second key frame according to the first edited posture data and the second edited posture data comprises:
performing interpolation calculation on the posture data corresponding to each frame of panoramic image data between the first key frame and the second key frame according to the first edited posture data and the second edited posture data to obtain interpolation posture data corresponding to each frame of panoramic image data between the first key frame and the second key frame; and
playing the video corresponding to the panoramic video data between the first key frame and the second key frame according to the interpolated posture data.

20. The video processing method according to claim 17, wherein the playing the video corresponding to the panoramic video data according to the edited posture data and the preview posture data comprises:
determining that there is no second key frame within a preset time range corresponding to the first key frame;
determining a first video frame corresponding to a time start point and a second video frame corresponding to a time end point within the preset time range;
performing interpolation calculation on posture data of the first key frame according to the preview posture data corresponding to the first video frame and the preview posture data corresponding to the second video frame to obtain first interpolation posture data corresponding to the first key frame; and
displaying the image corresponding to the first key frame according to the first interpolation posture data and the panoramic image data corresponding to the first key frame.
